(19) United States
(12) Patent Application Publication
(10) Pub. No.: US 2004/0020834 A1
(43) Pub. Date: Feb. 5, 2004

(54) Apparatus for separating sample components by liquid chromatography under pressure

(75) Inventors: Emil Mincsovics, Budapest (HU); Michel Manach, Meudon (FR); Laszlo Kecskes, Budapest (HU); Barnabas Tapa, Budapest (HU); Erno Tyihak, Budapest (HU)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Bionisis

(21) Appl. No.: 10/346,224

(22) Filed: Jan. 17, 2003

(30) Foreign Application Priority Data
Aug. 2, 2002 (FR) 0209899

(51) Int. Cl. B01D 15/08

(52) U.S. Cl. 210/198.2; 422/70; 73/61.52

(57) ABSTRACT

Apparatus for separating the components of a sample by OPLC type chromatography using liquid under pressure, the apparatus comprises a stationary phase forming one or more sample treatment paths and means for feeding moving phase to one end of the stationary phase, with means at the opposite end of the stationary phase for collecting moving phase, means for injecting moving phase also being provided at the sides of the stationary phase in order to eliminate edge effects in the fronts of sample components and in order to separate treatment paths from one another.

The invention relates to apparatus for separating the components of a sample by liquid chromatography under pressure of the type known as “over pressured layer chromatography” or as “optimum performance layer chromatography” (OPLC).

### BACKGROUND OF THE INVENTION

This technique consists in depositing a sample at one end of a layer of a stationary phase formed by a suitable material such as powder or particles of silica gel, alumina, magnesium silicate, cellulose, polyamide, etc., enclosed in leaktight manner between two walls so as to be subjected to an external pressure applied to said walls. The components of the sample are separated by being entrained through the stationary phase by means of a moving phase formed by a fluid under pressure. The walls defining the stationary phase are fitted with means for injecting the sample into the stationary phase and for feeding the stationary phase with the moving phase, said means being located at a first end of the stationary phase, and the walls are further fitted with means for collecting the sample and the moving phase at the other end of the stationary phase.

These means may define a single sample treatment path, the feed means and the collecting means being formed by transverse grooves in the walls, which grooves open out at the ends of the stationary phase.

In a variant, a plurality of parallel and juxtaposed treatment paths may be defined in the stationary phase between transverse grooves at the ends of the walls, forming the feed and collecting means, the various treatment paths being separated from one another by longitudinal partitions.

Depending on the embodiment, the stationary phase may be placed in a separation chamber of a device having means for feeding the moving phase and means for delivering the moving phase and the sample, or it may be housed initially in a cartridge which is subsequently placed in the above-specified device.

The flow of moving phase injected into the stationary phase travels therethrough in substantially uniform manner except in zones making contact with the side walls that extend from one end to the other of the stationary phase and that define the sides of the treatment path.

In such zones, the stationary phase is compressed to an extent that is different from in the remainder of the treatment path, and the flow speed of the moving phase therein is different, which is harmful to the effectiveness of separation and to the precision of analyses. This situation can be described in terms of a flow front of the moving phase in the stationary phase departing from being linear, where the front is substantially linear over most of its length and deforms at its ends close to the side walls by virtue of an “edge effect”.

### OBJECTS AND SUMMARY OF THE INVENTION

A particular object of the invention is to remedy that drawback in a manner that is simple and effective.

An object of the invention is to provide apparatus for separating the components of a sample by OPLC type chromatography, in which the fronts of the sample components are substantially linear over their entire extent, and in particular at their ends.

To this end, the invention provides apparatus of the above-specified type comprising a stationary phase formed of an appropriate medium placed between two walls, injector and feed means for injecting sample at a first end of the stationary phase and for feeding said end of the stationary phase with moving phase, and collecting means for collecting moving phase and sample components from the opposite end of the stationary phase, at least one sample treatment path being defined in the stationary phase between the feed means and the collecting means, the apparatus further comprising injector means for injecting the moving phase at the longitudinal sides of said treatment path at said first end of the stationary phase.

The invention thus makes it possible to eliminate edge effects at the ends of the fronts of the sample components in the stationary phase since the ends of these fronts are spaced apart from the fixed side walls by flows of the moving phase which do not contain any sample, such that a difference in flow speed along the side walls no longer has any incidence on separation of the components of the samples.

Eliminating these edge effects significantly increases the effectiveness of separation and the precision of analysis.

In a preferred embodiment of the invention, the above-mentioned means for injecting moving phase on either side of the treatment path are formed at the ends of the means for feeding the moving phase to the stationary phase.

Transverse grooves or analogous means formed at the ends of the stationary phase for feeding it with moving phase can be extended so as to form the injection means situated on either side of the treatment path, such that the moving phase also moves along the sides of the treatment path, on either side thereof.

In a variant, said means for injecting the moving phase may be independent of a transverse groove forming the means for feeding the treatment path with moving phase.

The invention applies both to circumstances in which the stationary phase comprises a single sample treatment path and to circumstances in which it comprises a plurality of juxtaposed parallel sample treatment paths that are separated longitudinally from one another by flow channels for the moving phase, which flow channels then have the combined functions of eliminating edge effects, protecting the sample components from the outside environment, and separating the various different paths.

The apparatus of the invention may be miniaturized on surfaces having a thickness of a few microns and an area lying in the range a few square millimeters (mm²) to a few hundreds of square centimeters (cm²).

The invention is also applicable to circumstances in which the stationary phase is in the form of a cylindrical column, moving phase injection means being provided at one end of the column to form a flow of moving phase around each sample treatment path in the stationary phase and to eliminate the edge effects against the surrounding wall.

### BRIEF DESCRIPTION OF THE DRAWINGS

The invention will be better understood and other characteristics, details, and advantages thereof will appear more clearly on reading the following description given by way of example and made with reference to the accompanying drawings, in which:

FIG. 1 is a diagrammatic plan view of apparatus of the invention;

FIG. 2 is a diagrammatic side view of the FIG. 1 apparatus;

FIGS. 3 and 4 are diagrammatic views from beneath of two sheets of plastics material forming a wall of the apparatus of FIGS. 1 and 2;

FIGS. 5 and 6 are fragmentary diagrammatic views on a larger scale and a section on lines V-V of FIG. 3 and VI-VI of FIG. 4;

FIG. 7 is a diagrammatic plan view of a variant embodiment of the apparatus comprising a plurality of parallel and juxtaposed treatment paths;

FIG. 8 is a diagrammatic plan view of a variant embodiment of the apparatus shown in FIGS. 1 to 6;

FIG. 9 is a diagrammatic plan view of a variant embodiment of the FIG. 7 apparatus;

FIG. 10 is a fragmentary diagrammatic view in axial section of another variant of the invention in which the stationary phase forms a cylindrical column;

FIG. 11 is a diagrammatic plan view of the top disk of the column;

FIG. 12 is a diagrammatic plan view of said disk in section on line XII-XII of FIG. 11;

FIG. 13 is a diagrammatic view from beneath of the bottom disk of the column; and

FIG. 14 is a diagrammatic view of the filter in section on line XIV-XIV of FIG. 13.

### MORE DETAILED DESCRIPTION

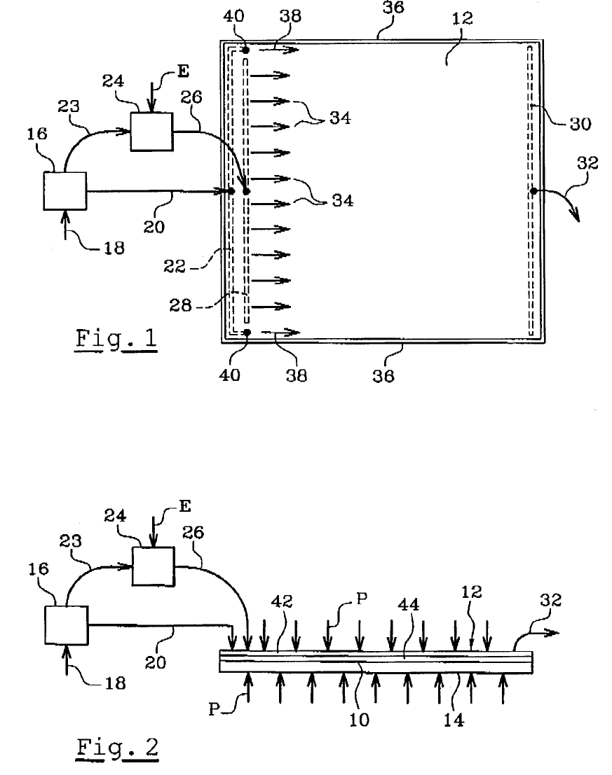

In FIGS. 1 to 6 which show apparatus having a single sample treatment path in highly simplified manner, reference 10 designates a stationary phase which is formed by a layer of material enclosed between two walls 12 and 14 made of a plastics material such as poly(tetrafluoroethylene), for example, with the stationary phase being constituted by monoliths of powder or particles of alumina, of silicate gel, of magnesium silicate, of cellulose, of polyamide, etc.

In preferred manner, the stationary phase 10 and the walls 12, 14 are in the form of a cartridge that is closed in leaktight manner, which cartridge is placed in an appropriate device enabling external pressure P to be exerted on its walls 12 and 14 as represented by arrows in FIG. 2, In a variant, the layer of stationary phase 10 may be placed inside a device which has the walls 12 and 14.

Means are associated with opposite longitudinal ends of the stationary phase 10 for the purposes of feeding it with moving phase, injecting sample material, and collecting the moving phase and the sample, and they are described in greater detail below

The means for feeding the moving phase comprise a pump 16 or other analogous pressurizing means having an inlet 18 connected to a tank of moving phase (in this case a suitable liquid) and having an outlet 20 connected to a transverse groove 22 formed in the top wall 12, for example, and opening out in the vicinity of the side walls defining the stationary phase 10 so that the moving phase can flow along the side walls of the stationary phase 10.

Another outlet 23 of the pressurizing means 16 feed injector means 24 for injecting a complex sample E which is to be separated into its components by OPLC. The outlet 26 of the injector means 24 open out into another transverse groove 28 in the top wall 12 which distributes the flow of moving phase and sample uniformly over nearly the entire width of the stationary phase 10, the groove 28 terminating a short distance away from the side walls 36.

At the opposite end of the stationary phase, another transverse groove 30 is formed in the top wall 12 and opens to the outside thereof through an orifice for connection to means 32 for extracting the liquid phase together with any sample components. This groove 30 extends over substantially the entire width of the stationary phase 10.

Other means, not shown, may be provided for controlling the rates at which the liquid phase is fed and collected, and also the outside pressure P that is applied to the stationary phase 10.

While the apparatus is in operation, the flow of moving phase advances uniformly from one end to the other of the stationary phase 10 as represented by arrows 34, except in the vicinity of the side walls 36 between which the stationary phase 10 is enclosed and which define the treatment path for the sample E.

The invention provides for causing a stream of moving phase that contains no sample to flow along the walls 36, as represented by arrows 38, going from the feed groove 22 to the collector groove 30, thereby eliminating edge effects at the ends of the fronts of sample components in the stationary phase.

For this purpose, the transverse feed groove 22 is extended beyond the ends of the groove 28 for distributing the moving phase together with the sample, and its ends 40 extend to the immediate vicinity of and along the side walls 36 substantially up to the level of the transverse groove 28 for distributing the sample, thereby forming means for injecting moving phase that extend parallel to the side walls 36 towards the transverse collecting groove 30 so as to deliver a flow of moving phase against the side walls 36. This flow does not contribute to separating the components of the sample in the stationary phase and it does not contain any sample, and it travels faster or slower than the moving phase in the remainder of the stationary phase, while nevertheless eliminating the above-mentioned edge effects and protecting the treatment path against the outside environment.

In a preferred embodiment of the invention, and as shown diagrammatically in FIGS. 2 to 6, one of the walls, for example the top wall 12, is made up of two superposed sheets 42 and 44 of a plastics material such as TEFLON (poly(tetrafluoroethylene)) having the grooves 22, 28 and the corresponding injection orifices formed therein.

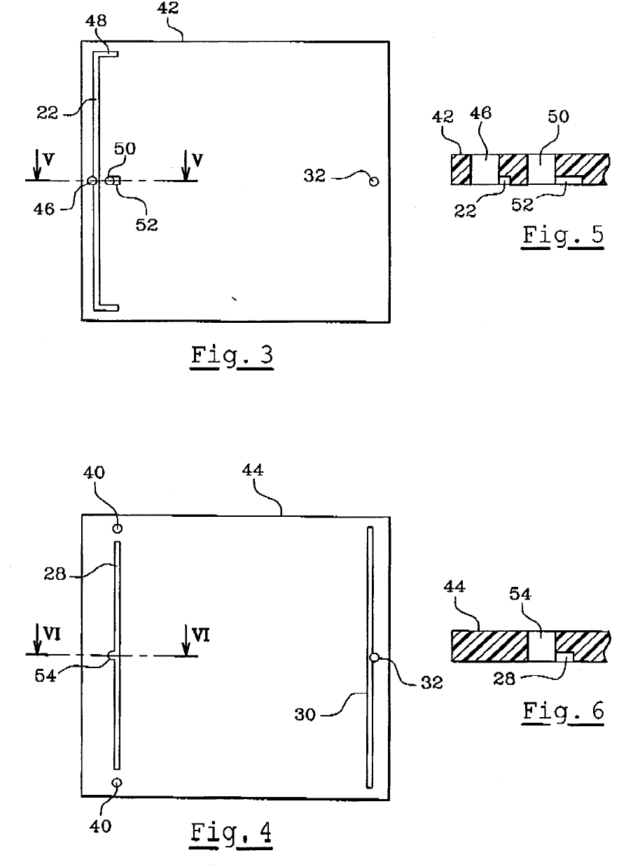

The bottom face or under face of the top sheet 42 is shown in FIG. 3 and the under face of the bottom sheet 44 is shown in FIG. 4.

The groove 22 is formed in the bottom face of the top sheet 42 along a transverse edge, and it is fed in its middle by an orifice 46 passing through the sheet 42, as shown. The ends 48 of the groove 22 extend perpendicularly to said groove towards the other transverse edge of the sheet 42.

A through orifice 50 is formed in the sheet 42 at a small distance from the orifice 46 and is for connection to the above-mentioned outlet 26. The orifice 50 opens out into a small longitudinal groove 52 in the bottom sheet of the face 42.

The groove 52 itself opens out via a through orifice 54 in the bottom sheet 44 whose bottom face is in contact with the stationary phase 10 and includes the transverse groove 28 for distribution purposes. The orifice 54 is substantially tangential to the groove 28.

Feeding the groove 28 “stepwise” makes it possible to limit the direct impact of the flow of moving phase against the stationary phase.

Furthermore, the ends 48 of the groove 22 formed in the sheet 42 open to the stationary phase via through orifices 40 in the sheet 44, which orifices may be of any desired section or shape and form the means for injecting the moving phase along the side walls 36.

The collecting transverse groove 30 is formed in the plate 44 and is connected to outlet means 32 comprising two through orifices formed through the plates 42 and 44, respectively.

Beads of porous sintered material may be disposed in the grooves 28 and 30 and also at the ends 40 in order to protect the stationary phase and make the flow of the moving phase more uniform.

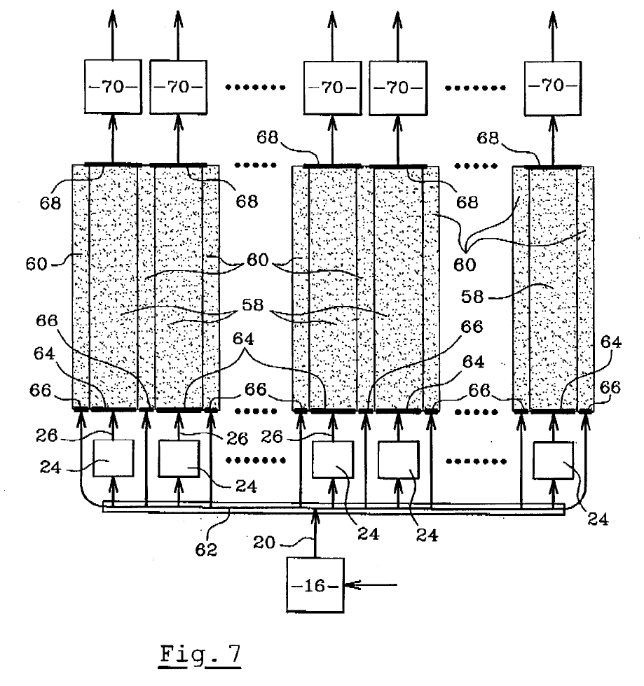

In the variant embodiment shown diagrammatically in FIG. 7, the stationary phase 10 no longer comprises a single treatment path, but a plurality of parallel paths 58 which are juxtaposed transversely and which are separated from one another by longitudinally-extending paths 60 along which the moving phase lows.

The apparatus shown in simplified manner in FIG. 7 comprises a pump 16 for feeding the moving phase, its outlet 20 being connected to a transverse groove 62 for distributing the moving phase, said groove 62 feeding sample injection means 24 each associated with a respective treatment path 58 and having outlets 62 connected to the distribution transverse grooves 64 provided at the ends of the treatment paths 58.

The feed groove 62 is also connected to small grooves or to injection orifices 66 provided on either side of the distribution grooves 64 and dimensioned so as to create longitudinal flow paths 60 of desired width on either side of each of the treatment paths 58.

At the opposite ends of the treatment paths 58, transverse collecting grooves 68 receive the moving phase delivered by the distribution grooves 64 and that which is injected by the orifice 66. These transverse collecting grooves 68 are connected to detector means 70 of known type.

It is thus possible to provide eight parallel treatment paths 58, for example, which are juxtaposed in a common layer of stationary phase, these eight paths being separated from one another and from the outer side walls by longitudinal paths 60 in which the moving phase flows.

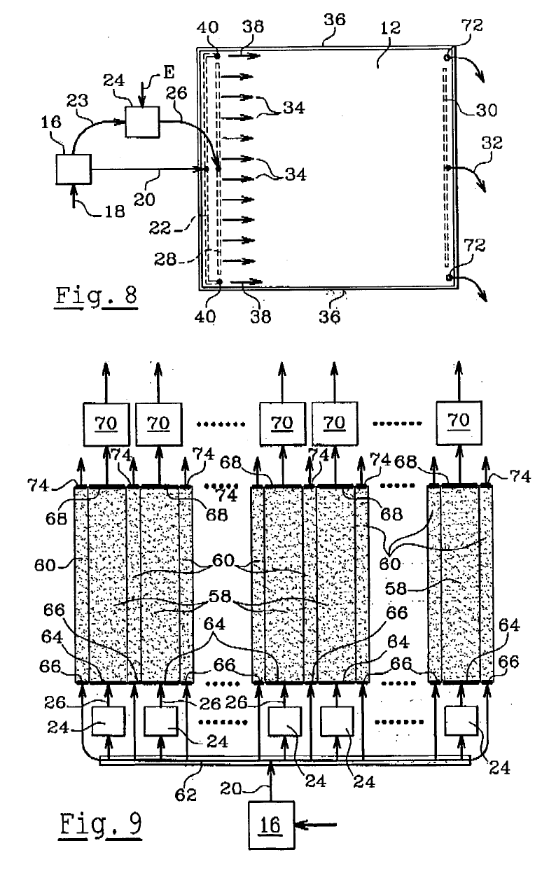

The apparatus shown in FIG. 8 differs from that shown in FIG. 1 in that it has orifices 72 formed through the top wall 12 of the apparatus at the ends of the flow paths for moving phase along the side walls 36, these orifices 72 being in line with the collecting transverse groove 30. In this way, the flows of moving phase along the side walls 36 which do not contribute to separating the components of the sample in the stationary phase leave the apparatus via the orifices 72 without being mixed with the sample components that are collected in the groove 30. Similarly, the apparatus shown in FIG. 9 differs from that of FIG. 7 in that the ends of the flow paths 60 for the moving phase have outlet orifices 74 which are independent of the transverse collecting grooves 68 formed at the ends of the treatment paths 58. Otherwise, the apparatus of FIG. 9 is identical to that of FIG. 7.

As mentioned above, the invention also applies when the stationary phase forms a cylindrical column of arbitrary section contained in a tube. Under such circumstances, the moving phase is injected into one end of the column of stationary phase via an annular channel surrounding the sample injection surface. This eliminates edge effects between the front of sample components and the inside wall of the tube, and separates treatment paths from one another.

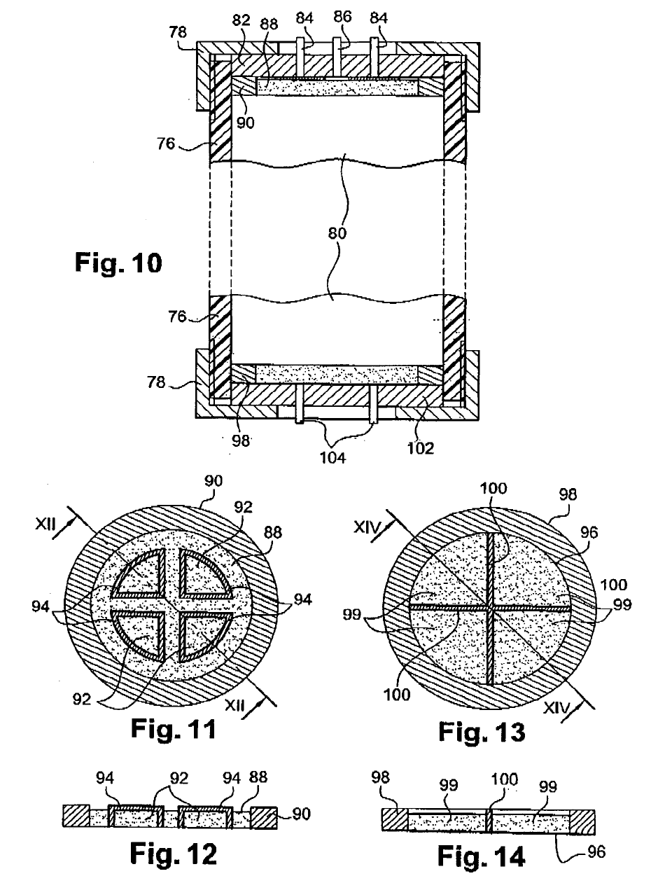

An embodiment of such apparatus is shown in FIGS. 10 to 14. It essentially comprises a cylindrical tube 76 of suitable rigid material, in particular steel or a suitable plastics material such as polyetherether-ketone (PEEK), the tube having threaded ends received in screw caps 78 for applying pressure to the stationary phase 80 which fills the tube 76. The top cap 78 bears against a top disk 82 engaged in the top end of the tube 76 and including ducts 84 for feeding sample with moving phase, and at least one duct 86 for feeding moving phase alone. The disk 82 bears against a disk 88 of porous material surrounded by a sealing ring 90 interposed between the disk 82 and the tube 76. Chambers 92 are defined in the disk 88 and they are separated from one another by leakproof partitions 94 extending transversely and longitudinally. Each chamber 92 is fed with sample and moving phase by a duct 84 which passes through a transverse partition 94. The or each duct 86 for feeding moving phase opens out into the top of the disk 88 between the chambers 92.

The bottom end of the tube 76 likewise includes a porous bottom disk 96 surrounded by a sealing ring 98 interposed between the disk 96 and the tube 76, the stationary phase being supported by the disk 96 and the ring 98. The disk 96 is subdivided into four independent sectors 99 by leakproof longitudinal partitions 100. The disk 96 and the ring 98 rest on a bottom disk 102 engaged in the bottom end of the tube 76 and bearing against the bottom cap 78. Ducts 104 carried by the bottom disk 102 connect respective sectors 99 to external detector means (not shown).

In this apparatus, the chambers 92 of the porous top disk 88 and the sectors 99 of the porous bottom disk 96 define four sample treatment paths in the stationary phase column 80, which paths are parallel and separated from one another and from the tube 76 by flows of moving phase which are fed by the above-mentioned duct(s) 86.

In this embodiment, the flows of moving phase are collected at the outlet together with the sample components and the moving phase coming from the sample treatment paths. In a variant, it is possible to provide the bottom disk 102 with ducts for collecting the above-mentioned flows of moving phase that have been used to keep the treatment paths separate from one another and from the tube 76.

In general, the invention consists in injecting a flow of moving phase for separating the various treatment paths from one another and for eliminating edge effects between a fixed wall and the moving phase flowing through the stationary phase.

What is claimed is:

1/ Apparatus for separating the components of a sample by OPLC type liquid chromatography, the apparatus comprising a stationary phase formed of an appropriate medium placed between two walls, injector and feed means for injecting sample at a first end of the stationary phase and for feeding said end of the stationary phase with moving phase, and collecting means for collecting moving phase and sample components from the opposite end of the stationary phase, at least one sample treatment path being defined in the stationary phase between the feed means and the collecting means, the apparatus further comprising injector means for injecting the moving phase at the longitudinal sides of said treatment path at said first end of the stationary phase.

2/ Apparatus according to claim 1, further comprising collecting means for collecting moving phase arranged at said opposite end of the stationary phase to receive said flow of moving phase injected at the longitudinal sides of said treatment path.

3/ Apparatus according to claim 1, wherein said injector means are separate from the means for injecting sample and feeding moving phase.

4/ Apparatus according to claim 3, wherein said moving phase injector means are at the ends of the means for injecting sample and feeding moving phase.

5/ Apparatus according to claim 1, including at the first end of the stationary phase a transverse feed groove for feeding moving phase and a transverse groove for distributing sample and moving phase, the transverse feed groove being extended beyond the ends of the groove for distributing sample and moving phase in order to form the injector means for injecting the moving phase at the longitudinal sides of the treatment path.

6/ Apparatus according to claim 1, including at the first end of the stationary phase a transverse groove for distributing sample and feeding moving phase to the treatment path, and at the ends of said groove it further includes separate grooves for injecting moving phase at the longitudinal sides of the treatment path.

7/ Apparatus according to claim 5, wherein a groove for feeding moving phase is formed between two sheets that are superposed in leaktight manner, for example sheets of plastics material, which sheets constitute one of the above-mentioned walls, a groove for distributing sample and moving phase being formed in that one of the sheets which comes into contact with the stationary phase, the other one of said sheets having through orifices for injecting sample and for feeding moving phase.

8/ Apparatus according to claim 1, wherein the stationary phase forms a single sample treatment path defined between the walls by side walls, and wherein the moving phase injection means are situated between said side walls and the treatment path.

9/ Apparatus according to claim 1, wherein the stationary phase comprises a plurality of parallel and juxtaposed treatment paths which are separated longitudinally from one another by moving phase flow paths.

10/ Apparatus according to claim 9, wherein the stationary phase is defined between outer side walls and comprises moving phase flow paths along said side walls.

11/ Apparatus according to claim 1, including means provided at said opposite end of the stationary phase for collecting the flow of moving phase injected at the sides of a treatment path independently of collecting moving phase and sample components at the end of the treatment path.

12/ Apparatus according to claim 1, the apparatus being miniaturized.

13/ Apparatus according to claim 1, wherein the stationary phase is in the form of a cylindrical column, and wherein moving phase injector means are provided at one end of said column to form a flow of moving phase around each sample treatment path.
